(19) United States
(12) Patent Application Publication
(10) Pub. No.: US 2004/0224597 A1
(43) Pub. Date: Nov. 11, 2004

(54) Miniature motorized vehicles on retrievable tether line

(76) Inventors: Elliot Rudell, Rancho Palos Verdes, CA (US); George T. Foster, Long Beach, CA (US); Raymond Fisher, Torrance, CA (US)

Correspondence Address: IRELL & MANELLA LLP, 840 NEWPORT CENTER DRIVE, SUITE 400, NEWPORT BEACH, CA, 92660, US

(21) Appl. No.: 10/865,021

(22) Filed: Jun. 9, 2004

Related U.S. Application Data
(63) Continuation of application No. 10/427,498, filed on Apr. 30, 2003.

(51) Int. Cl. H01J 9/38

(52) U.S. Cl. 445/15

(57) ABSTRACT

A novel aquatic system that includes a motorized housing which can be propelled across a body of water. The motorized housing is coupled to a tethering line that can be used to provide a command to stop and/or control the movement of the housing. The line may be coupled to a rod and reel used to pull the housing back to the operator. The housing may be shaped as a fish and contain an off-center weight that vibrates and provides the simulated experience of “catching the fish”.

### BACKGROUND OF THE INVENTION

1. Field of the Invention

The present invention relates to a toy aquatic system with a tether line that is attached to a vehicle which moves across a body of water.

2. Background Information

There have been developed a number of radio controlled (RC) toy boats that can be propelled across a body of water. RC controlled boats typically include a motor that drives a small propellor, and a receiver which receives wireless control signals from a hand held transmitter. The operator can provide command signals to power and move the boat about the water through the hand held transmitter.

The boat may move to a location on the water that is outside the range of the transmitter. When this happens the operator will either retrieve or lose the boat. Additionally, the boat is typically powered by batteries. The power of the batteries may be reduced to a level such that the operator can no longer control the boat. Again the boat must either be retrieved or lost.

There has been marketed a novelty product under the trademark BASS FISHIN' that simulates the experience of fishing. The BASS FISHIN' product includes a hand held LCD display that has a reel handle. The user “casts” the product and then “reels” in an imaginary line displayed by the LCD. The product vibrates when the operator receives a “bite” to simulate the feel of catching a fish.

### BRIEF SUMMARY OF THE INVENTION

An aquatic system that includes a motor and a propellor that are coupled to a housing. The system also has a line coupled to the motor.

### BRIEF DESCRIPTION OF THE DRAWINGS

FIG. 1 is an illustration showing an aquatic system;

FIG. 2 is an illustration showing a motorized boat of the aquatic system;

FIG. 3 is an alternate embodiment of the aquatic system;

FIG. 4 is an illustration showing a motorized toy fish of the aquatic system shown in FIG. 3;

FIG. 5 is an illustration showing an alternate embodiment of the aquatic system;

FIG. 6 is an illustration showing an alternate embodiment of the aquatic system.

### DETAILED DESCRIPTION

Disclosed is a novel aquatic system that includes a motorized housing which can be propelled across a body of water. The motorized housing is coupled to a tethering line that can be used to provide a command to stop and/or control the movement of the housing. The line may be coupled to a rod and reel used to pull the housing back to the operator. The housing may be shaped as a fish and contain an off-center weight that vibrates and provides the simulated experience of “catching a fish”.

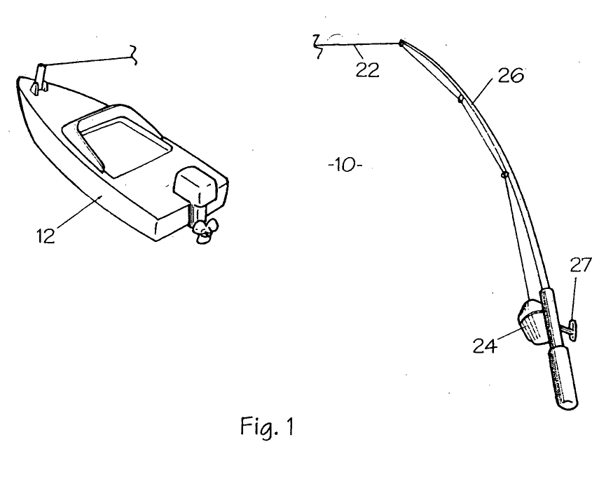

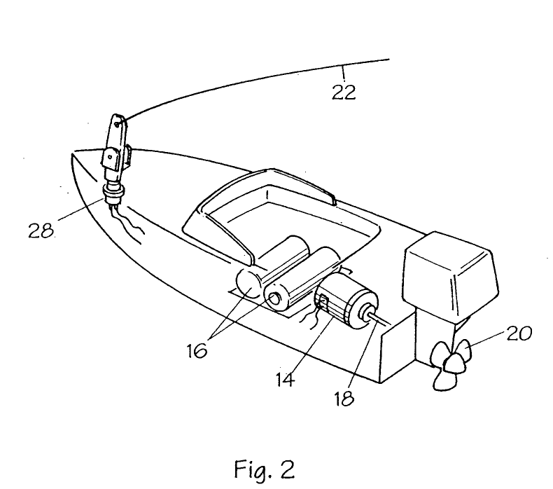

Referring to the drawings more particularly by reference numbers, FIGS. 1 and 2 show an aquatic system 10. The aquatic system 10 may include a housing 12 that is shaped as a boat which can float on a body of water. By way of example, the housing 12 may be constructed from a molded plastic material. The housing 12 contains a motor 14 that is powered by one or more batteries 16. The motor 14 has an output shaft 18 that rotates and drives a propellor 20. The motor driven propellor 20 can move the housing 12 across a body of water.

The system 10 includes a line 22 that is coupled to the housing 12. The line 22 may be coupled to a reel 24 and a rod 26. The reel 24 may include a spool (not shown) and a handle 27 that allow the line 22 to be pulled in or let out. The line 22 may be constructed from a metal or non-metal material.

The line 22 is attached to a switch 28 that is coupled to the motor 14 and the batteries 16. The switch 28 can be moved between an open position and a closed position. In the closed position the switch 28 allows power to the motor 14. Opening the switch 28 shuts off the motor 14. The switch 28 can be moved to the open position by pulling the line 22.

In operation, a user can push the switch 28 and turn on the motor 14. The housing 12 is then placed in a body of water. The housing 12 can be propelled across the water by the motorized propellor 20. The line 22 remains attached to the switch 28 and is pulled out of the reel 24. The user can turn the motor 14 off by pulling the line 22 and pivoting the switch 28. The user can then pull in the housing 12 by rotating the reel handle 27.

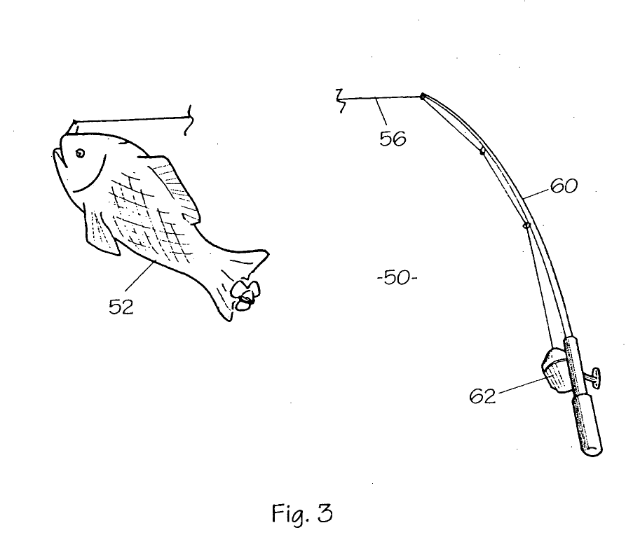

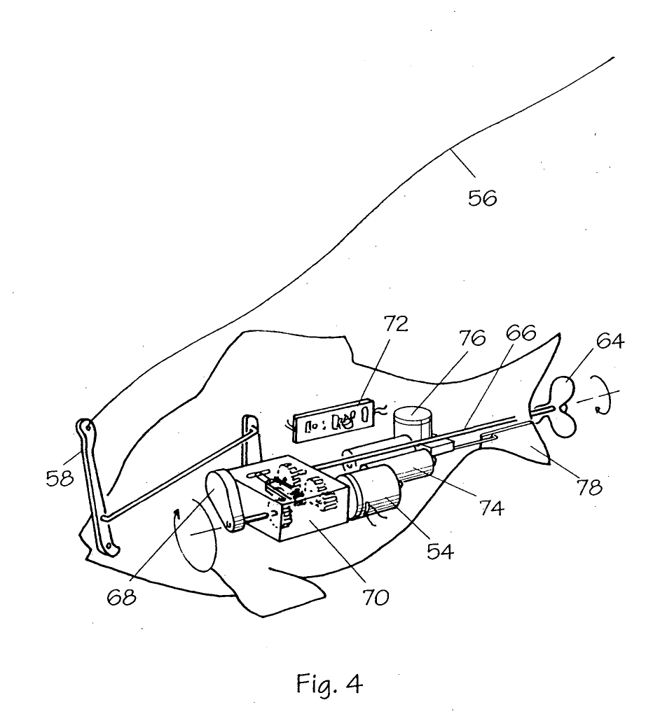

FIGS. 3 and 4 show an alternate embodiment of an aquatic system 50. The system 50 includes a housing 52 that is shaped as a toy fish. The housing 52 contains a motor 54 that is coupled to a line 56 by a switch 58. The switch 58 is coupled to a rod 60 and a reel 62. The line 56 may be a metal or non-metal material.

The motor 54 may be coupled to a propeller 64 by a drive shaft 66. The motor 54 may also be coupled to an off-center weight 68 by a gear assembly 70. The off-center weight 68 may be rotated by the motor 54 to induce a vibration in the housing 52. The gear assembly 70 may couple the motor 54 to either the propeller 64, or the off-center weight 68.

The motor 54 may also be coupled to a printed circuit board assembly 72 that varies the motor speed in accordance with the position of the switch 58. The circuit board 72 and motor 54 may be powered by batteries 74.

In operation, the user may activate the motor 54 and place the fish housing 52 into a body of water. The speed of the motor 54 may be varied by pulling the line 56 and moving the switch 58. Movement of the housing 52 may simulate a fish swimming through water. Pulling the switch 58 all the way back may cause the gear assembly 72 to de-couple the motor 54 from the propeller 64 to stop movement of the housing 52. This allows the user to pull in the fish housing 52. The off-center weight 68 can be rotated by the motor 54 to induce a vibration in the housing 52. The vibration provides resistance to the user pulling in the housing, thereby providing the sensation of “catching a fish”. The switch 58 may also vary the speed of the motor 54 so that pulling the line 56 changes the speed of the housing 52.

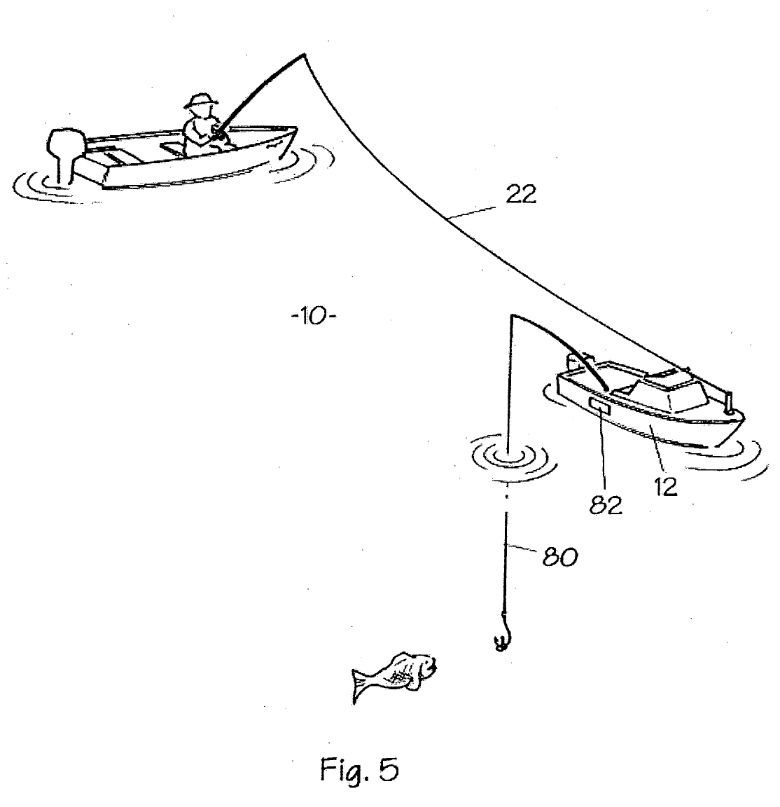

FIG. 5 shows an alternate embodiment of a system 10′ that has a second line 80 attached to the housing 12. The system 10′ can be used by moving the housing 12 across the water such that the second line 80 can be used to catch a live fish. The housing 12′ may include a motor 82 that can pull up the second line 80.

For the embodiments shown in FIGS. 1-4, the printed circuit board 72 may also contain a receiver (not shown) that receives command signals transmitted across the line 56. The printed circuit board 72 may be coupled to another motor 76 that moves a rudder 78 in accordance with the control signals. Such an arrangement allows the user to control the direction of the fish. Likewise, the control signals may control the speed of the fish or boat.

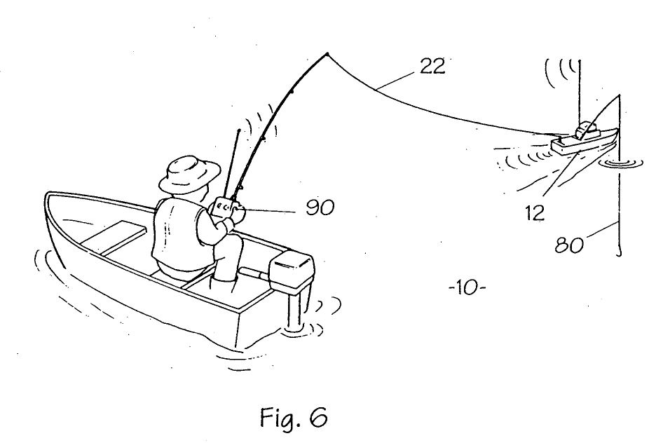

FIG. 6 shows another embodiment of a system 10″ that has a radio controlled transmitter 90 that can send command signals over the line 22 to a receiver (not shown) in the housing 10. The housing 10 may include electrical circuits, a rudder, linkages, etc. that allow the user to control the movement of the housing 12 through the transmitter 90. The line 22 constrains the movement of the housing 10 so that the user does not lose the boat.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An aquatic system, comprising:
a fish shaped housing;
a motor coupled to said housing;
a propulsion device coupled to said motor;
a first line coupled to said switch;
a vibration generator coupled to said fish shaped housing; and
a switch that is connected to said first line and said vibration generator, said switch couples said motor to said vibration generator when said first line is pulled.

2-3. (canceled)

4. The system of claim 1, further comprising a switch that is coupled to said first line and said motor.

5. The system of claim 1, further comprising a rod that is coupled to said first line.

6. The system of claim 5, further comprising a reel that is coupled to said first line and said rod.

7. The system of claim 1, further comprising a transmitter and a receiver that are coupled to said first line.

8. (canceled)

9. The system of claim 1, wherein said vibration generator includes an off-center weight coupled to said motor.

10. The system of claim 1, wherein said fish shaped housing includes a rudder.

11. An aquatic system, comprising:
fish shaped housing means for floating on the water;
propulsion means for moving said housing means across the water;
vibration means for vibrating said fish shaped housing means;
motor means for driving said propulsion means and said vibration means;
a line; and,
switch means for coupling said motor means to said vibration means when said line is pulled.

12-14. (canceled)

15. The system of claim 14, further comprising a rod that is coupled to said first line.

16. The system of claim 15, further comprising a reel that is coupled to said first line and said rod.

17. (canceled)

18. (canceled)

19. The system of claim 14, wherein said vibration means includes an off-center weight coupled to said motor.

20. The system of claim 11, wherein said fish shaped housing means includes a rudder.

21. An aquatic system, comprising:
a fish shaped housing;
a motor coupled to said fish shaped housing;
an off-center weight coupled to said motor;
a propeller coupled to said motor;
a first line;
a switch that couples said motor to said off-center weight when said first line is pulled;
a reel coupled to said first line; and,
a rod coupled to said first line and said reel.

22-23. (canceled)

24. The system of claim 21, further comprising a transmitter and a receiver that are coupled to said first line.

25. (canceled)

26. The system of claim 21, wherein said fish shaped housing includes a rudder.

27. A method for operating an aquatic system, comprising:
propelling a fish shaped housing across a body of water while being coupled to a line;
pulling the line to initiate vibration of the fish shaped housing and,
pulling the fish shaped housing across the water with the line.

28. The method of claim 27, reeling in the line and fish shaped housing.

29. (canceled)
